(19) United States
(12) Patent Application Publication
(10) Pub. No.: US 2007/0286169 A1
(43) Pub. Date: Dec. 13, 2007

(54) Radio flag (focused listening and advertising guide) system and method

(76) Inventor: Anthony Roman, Newport Beach, CA (US)

Correspondence Address: CISLO & THOMAS, LLP, 233 WILSHIRE BLVD, SUITE 900, SANTA MONICA, CA, 90401-1211, US

(21) Appl. No.: 11/804,488

(22) Filed: May 18, 2007

Related U.S. Application Data
(60) Provisional application No. 60/801,227, filed on May 18, 2006.

(51) Int. Cl. H04L 12/66

(52) U.S. Cl. 370/352

(57) ABSTRACT

A free, wireless, network-based system and method for providing listeners with managed, personalized, valued radio broadcast content, in real time, from a broadcasting entity, by way of a mobile device, for offering a mobile marketing medium to advertisers in order to micro-target consumers with advertisement, for leveraging unmatched psychographics and demographics, and for eliminating a need to surf radio channels, the system and method involving a network, a flagging software being made available via the network in a website, and at least one mobile device for entering user information by at least one user and for receiving, playing, storing, and retransmitting, radio broadcast content, the at least one mobile device being capable of interfacing with the network.

### CROSS-REFERENCE TO RELATED APPLICATION(S)

This document is a non-provisional patent application which is related to, and claims priority from, U.S. Provisional Patent Application Ser. No. 60/801,227, entitled “RadioFlag System Utilizing F.L.A.G. Technology (Focused Listening and Advertising Guide),” filed on May 18, 2006, the disclosure of which is hereby incorporated in its entirety by reference.

### TECHNICAL FIELD

The present invention technically relates to systems and methods for matching listeners with sound providers. More particularly, the present invention technically relates to systems and methods for matching radio listeners with radio broadcast providers. Even more particularly, the present invention technically relates to systems and methods for matching radio listeners with selected and targeted radio broadcast content.

### BACKGROUND ART

The currently existing related art involves several systems and methods for providing music or other radio broadcast content. Radio retains its position as the mainstay medium, according to the latest total radio listening estimates compiled by RADAR®, the radio network and national audience measurement service of Arbitron, Inc. Initial findings by RADAR indicate that, over the course of a typical week, radio reaches 93% of all persons and reaches more than 94% of adults who live in a household with an income of $75,000 or more. Further, 94% of college graduates listen to radio; 81% of adults listen to radio while in their cars; and 24% of adults listen to radio at work.

Most conventionally, terrestrial radio stations, i.e., AM/FM radio, exist which provides some limited programming. More recently, satellite radio services, such as SIRIUS®, provide a wider variety of radio programming. Listeners may also download music online via their personal computers. However, the common problem with the foregoing related art systems and methods is that they still require the user to “channel-surf” in order to find desirable music or other radio broadcast content. Thus, a long-felt need is seen to exist for a system and a method for eliminating the need to channel-surf for identifying and selecting desirable radio broadcast content.

### DISCLOSURE OF THE INVENTION

The present invention addresses the foregoing problems in the related art in a system and corresponding methods for providing listeners with managed, personalized, valued radio broadcast content, in real time, from a broadcasting entity, by way of a mobile device, for offering a mobile marketing medium to advertisers in order to micro-target consumers with advertisement, for leveraging unmatched psychographics and demographics, and for eliminating a need to surf radio channels. The present invention involves a free, wireless, network-based system which generally comprises a network, a flagging software being made available via the network in a website, and at least one mobile device for entering user information by at least one user and for receiving, playing, storing, and retransmitting radio broadcast content, the at least one mobile device being capable of interfacing with the network.

The present invention also involves a method of creating a free, wireless, network-based system for providing listeners with managed, personalized, valued radio broadcast content, in real time, from a broadcasting entity, by way of a mobile device, for offering a mobile marketing medium to advertisers in order to micro-target consumers with advertisement, for leveraging unmatched psychographics and demographics, and for eliminating a need to surf radio channels. The method of providing the system generally comprising the steps of providing a network, providing a flagging software being made available via the network in a website, and providing at least one mobile device for entering user information by at least one user and for receiving, playing, storing, and retransmitting radio broadcast content, the at least one mobile device being capable of interfacing with the network.

The present invention also involves a corresponding method of providing listeners with managed, personalized, valued radio broadcast content, in real time, from a broadcasting entity, of offering a mobile marketing medium to advertisers in order to micro-target consumers with advertisement, of leveraging unmatched psychographics and demographics, and of eliminating a need to surf radio channels, by way of a free, wireless, network-based system. This method generally comprising the steps of providing the free, wireless, network-based system, the system providing step comprising the steps of providing a network, providing a flagging software being made available via the network in a website, and providing at least one mobile device for entering user information by at least one user and for receiving, playing, storing, and retransmitting radio broadcast content, the at least one mobile device being capable of interfacing with the network; registering at least one user, using the flagging software as at least one subscriber; using the system by the at least one subscriber, thereby matching the at least one subscriber with at least one radio broadcast content; and downloading the at least one radio broadcast content via the at least one mobile device.

The present invention also involves utilizing a market opportunity hitherto untapped. Major companies are investing in exclusive campaigns and technologies that are aimed at mobile marketing, and, for some businesses, this has proven highly successful. Marketers are just beginning to realize that the mobile lifestyle cuts across socioeconomic barriers. Most people in the United States have a cellular phone. With 200 million handsets currently sold, everyone can participate in mobile marketing. Unlike the Internet, cellular phones are an extension of the user. Worldwide mobile advertisement spending has topped $870 million in the year 2006, and is expected to explode in the United States alone to $10 billion by the year 2010. Mobile advertisements are capturing detailed demographics and consistently more than a 28 percent response rate. For mobile marketing campaigns to be effective, the advertisements must be accompanied by original and creative content valued by mobile phone users.

Society's constant thirst for information and entertainment in the 21^{st} century, has obviously sparked rapid growth in radio listenership, especially in the talk radio segment, thereby leaving between 34,000,000 and 80,000,000 weekly talk show addicts alone, coping with programming overload and unpredictability. FM youth talkers who address social and political issues, are even capturing young audiences. Avid listeners are without any direction, listening to their favorite stations, thereby hoping that their specific interests and favorite music will be the focus of programmers. Unlike television programming, where all shows and guests are programmed long in advance and viewers are guaranteed that they will not miss their favorites by having access to TV guides and other forms of available schedules, radio listeners float aimlessly through airwave space, waiting to be served up pot luck programming. Everyday, there are more than 10,200 guests that appear on approximately 6,000 radio talk or interview shows across America. In comparison, only approximately 988 TV shows exist, and 57% of all radio listeners desire better search functions for station format alone. Thus, a long-felt need for radio scheduling and display technologies exists.

The present invention involves a “value” proposition concept. The system is a wireless and Internet-based (www.radioflag.com) for providing listeners with managed and personalized valued radio content real time via mobile device free of charge, thereby ultimately offering advertisers a mobile marketing medium to micro-target consumers with their messages, leveraging unmatched psychographics and demographics generated by the system subscribers. Proprietary technology will flag radio shows and on air content of interest, specified by unique subscribers/listeners to the system, alerting them to tune-in. As such, users desire to eliminate switching stations only to find out that the user just missed another rare interview with his/her favorite personality, a specific topic of interest, or exclusive story of great importance. In addition, text-directed podcast downloads of desired radio content sent to a personalized listening library for later downloads is a mobile device function in the present system should an alert to tune-in be received at an inconvenient listening time for the user.

Advantages of the present invention include, but are not limited to, providing listeners with managed, personalized, valued radio broadcast content, in real time, from a broadcasting entity, offering a mobile marketing medium to advertisers in order to micro-target consumers with advertisement, leveraging unmatched psychographics and demographics, eliminating a need to surf radio channels, increasing driving safety by eliminating the need for leaning over to channel-surf, and optimizing a listener's enjoyment of radio. Other features of the present invention are disclosed, or are apparent, in the section entitled “Mode(s) for Carrying-Out the Invention,” disclosed, infra.

### BRIEF DESCRIPTION OF THE DRAWING(S)

For a better understanding of the present invention, reference is made to the below-referenced accompanying Drawing(s). Reference numbers refer to the same or equivalent parts of the present invention throughout the several figures of the Drawing(s).

FIG. 1 is a schematic diagram of a radio flagging system, in accordance with the present invention.

FIG. 2 is a schematic diagram of assistance provided by the plurality of staff members in a radio flagging system shown in FIG. 1, in accordance with the present invention.

FIG. 3 is a schematic diagram of a plurality of scanners being users in a radio flagging system, in accordance with the present invention.

FIG. 4 is a schematic diagram of an advertisement sending step in the present method using a radio flagging system, in accordance with the present invention.

FIG. 5 is a schematic diagram of a registering step in the present method using a radio flagging system, wherein a user profile is generated, in accordance with the present invention.

FIG. 6 is a schematic diagram of a user chat feature of a radio flagging system, in accordance with the present invention.

FIG. 7 is a schematic diagram of a podcasting feature of a radio flagging system, in accordance with the present invention.

FIG. 8 is a schematic diagram of an interactive advertisement feature of a radio flagging system, wherein a user participates with an advertiser in furthering advertising by making an endorsement of the advertiser's products or services by using a digital photograph of the user and connecting such photograph with a form-advertisement or slogan, in accordance with the present invention.

### MODE(S) FOR CARRYING OUT THE INVENTION

The present invention generally involves a radio program guide alert system 1000, i.e., a flagging system, and its technology, which comprises real time notifications via a mobile device, such as a mobile phone, 24 hours per day and 7 days per week. The flagging software enables the system 1000 to seek radio shows and on air-content of interest, which are specified by subscribers to the system 1000, and to alert those subscribers to “tune-in” the alerted radio broadcast content. Subscribers of the system 1000 will no longer have to resort to switching stations, as otherwise would be the case in the related art, only to discover that they have missed a rare interview with their favorite personalities, favorite topics, or stories of great importance.

In the system 1000, subscribers go to the website (www.RadioFlag.com), register, and program their interests, whereby the system 1000 generates their profiles. In particular, they enter user information or data, such as favorite radio stations, music, hosts, celebrities, athletes, sports teams, politicians, shows, etc. They program topics of interests, such as politics, celebrity gossip, movies, sports, food, law, religion, traffic, etc. Subscribers program their interests from the most basic to most specific levels, if desired. They also program their most likely radio listening and driving schedules. They program the degree to which, or frequency with which, they wish to be notified of radio programming. When subscribers are in a radio listening mode, they can activate the flagging system 1000 on a mobile device, e.g., a cellular phone, a headset, a PDA, and a dash-top RadioFlag™ device. The mobile device is also screen-oriented.

Using the present invention, subscribers casually listen to music on their radios, after having programmed their data into the system 1000, whereby profiles are generated in order to alert the subscribers to a broadcast of interest, wherein their cellular phones suddenly buzz them, thereby alerting them of radio broadcast content of interest. Pleasantly surprised, the subscribers are then furnished with the information and entertainment they greatly value without any effort or distraction in searching or waiting. The system 1000 tracks user habits as well. In this case, user habits are related to listening trends which are monitored in real time, thereby providing useful marketing and programming information to station managers and advertisers, thereby leading to better programming, and thereby ultimately resulting in a better radio listening experience.

Additional features of the system 1000 are as follows. Any station's pre-programmed show information will be posted on the system 1000 website for scheduled listening. Users can call, 24 hours per day and 7 days per week, to remotely re-program their user information in order to regenerate their profiles. Notification is made available of available podcasting downloads of missed shows or segments. Even if the user has not programmed specific interests in the user information, the system 1000 will make suggestions based on profile and history. A webpage is updated daily with programming recommendations based on the most current hot topics or events, as they unfold by the hour, day, week, or month. When traveling out of the user's normal driving vicinity, the system 1000 will automatically switch and search stations in the new driving area when programmed to do so. A search engine interface option is also available, whereby matching the search options with the alerted programming of interest is performed, e.g., the flagging software may ask: “Should a subscriber receive an alert to tune into an on-air topic related to real estate investing in New York?” If the answer to such query is “yes,” the system 1000 then searches listings which include New York realtors and real estate investment firms. The present invention system 1000 comprises a feature for receiving advertisement revenue generated by any affiliated search engine, e.g., Google® or Yahoo®.

The system 1000 also comprises a feature for “Real-Time Immediate Targeted Text Advertising” (using short messaging service or “SMS”). Targeted text and/or video advertisements are matched with listeners utilizing the system 1000. The advertisements accompany the alerts to subscribers. By offering incentives to listeners, the system 1000 is made available free of charge to the subscribers. Revenue is, instead, generated by selling cellular phone video and text advertising to marketers who are seeking to reach specific target markets. Marketers advertise using the system 1000 to reach targeted customers based on listeners' profiles, specifically their listening habits and interests. Text and/or video advertisements will only appear either when an alert has been sent to a subscriber or when permitted by the subscriber. The subscriber has pre-authorized the system 1000 to send advertisement messages in exchange for the free service provided by the system 1000. In order to avoid becoming a nuisance to the subscriber, the number of advertisements is limited. For instance, some marketer's advertisements may appeal more to subscribers who drive during the hours from 6:00 am to 9:00 am, as opposed to those who drive during the hours from 4:00 pm to 7:00 pm, or to subscribers who drive on one freeway/expressway, as opposed to those who drive on another freeway/expressway. A listening driver who is traveling a specific route during a specific time of the day may be a candidate for a marketer who has a store located along such route and wishes to reach the listening driver with a special offer or a coupon, thereby increasing the probability that the listening driver may stop and make a purchase. All alerts are weighted with a score based on listening importance so that subscribers are not overloaded with alerts.

Additional incentives will be offered to subscribers who forward advertisements to others who may find them of interest (retransmission), thereby creating a viral marketing effort on the behalf of advertisers. The benefit of text messages is that a user can pass such messages to friends in connection with the user's name, whereby an environment of trust is better established for the advertiser. Advertisements are also sent to subscribers on behalf of marketers, based on a subscriber's profile, thereby indicating whether the subscribers are actually listening to stations where the marketer's product are also advertised, and thereby creating a synergistic, coordinated, marketing effort for advertisers.

The system 1000 also comprises a search engine using speech-recognition technology that scans or searches spoken content on all radio stations, including those broadcasting on terrestrial, satellite, and over the Internet, that filters the content and distributes a SMS or a text message which alerts the subscribers of pre-qualified content of interest. Advertisements that match the profile of the subscriber, along with other demographics, are associated with the notification in the form of a text message. For instance, a subscriber, being notified of a broadcast concerning a health topic, would receive the alert accompanied by a SMS advertisement for a health food product or a health food store.

To eliminate the need for manual data entry when scanning the radio, the system 1000 incorporates speech-recognition technology that transforms spoken words into alphanumeric text and navigational commands recognizable by a personal computer (PC). The two primary components of speech recognition exist. The first piece, called the acoustic model, analyzes the sounds of a voice and converts those sounds into phonemes, the basic elements of speech. The English language contains approximately fifty phonemes. Speech-recognition technology breaks-down a voice by, using the acoustic model to remove noise and any unnecessary information, such as changes in volume, using mathematical calculations, thereby reducing the data to a spectrum of frequencies (the pitches of the sounds), analyzing the data, and converting the words into digital representations of phonemes. The second major component of speech-recognition software is the language model. The language model analyzes the content of speech and compares the combinations of phonemes to the words in its digital dictionary, a huge database of the most common words in the English language.

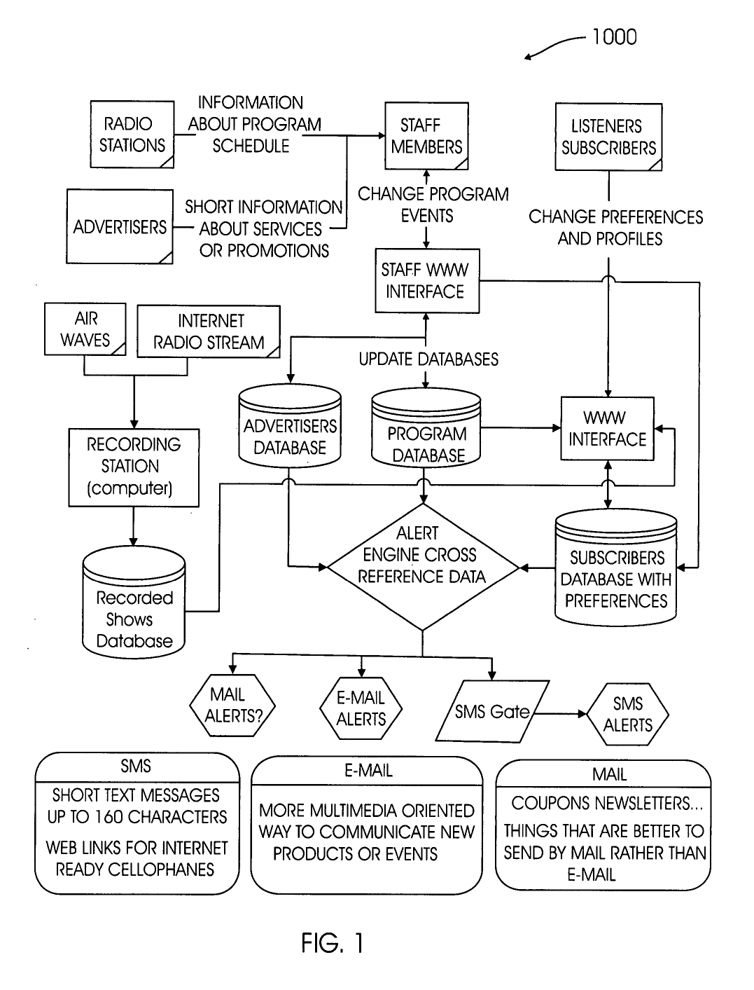

FIG. 1 illustrates, in a schematic diagram, an outline of a radio flagging system 1000, in accordance with the present invention. The system 1000 comprises a technology in flagging software (a comprehensive package) that will scan or search spoken content on all radio stations, including those broadcasting on terrestrial, satellite and over the Internet. Driven by the flagging software, including a search and match engine, the system 1000 seeks verbal content, filters it, and distributes a message via SMS or via text message alerts, thereby notifying subscribers of pre-qualified valued radio content and text advertisements of potential interest. As more and more mobile phones become equipped with video and audio applications, a sampling of a broadcast of interest is also sent via the system 1000. Advertisements matching the profile of the subscriber along with other psychographic and demographic data, are matched with the notification which may be accompanied by a text message and/or an alert message. For example, a subscriber, who may have been notified of a broadcast concerning a health topic, would receive the alert accompanied by a SMS advertisement for a health food product or store.

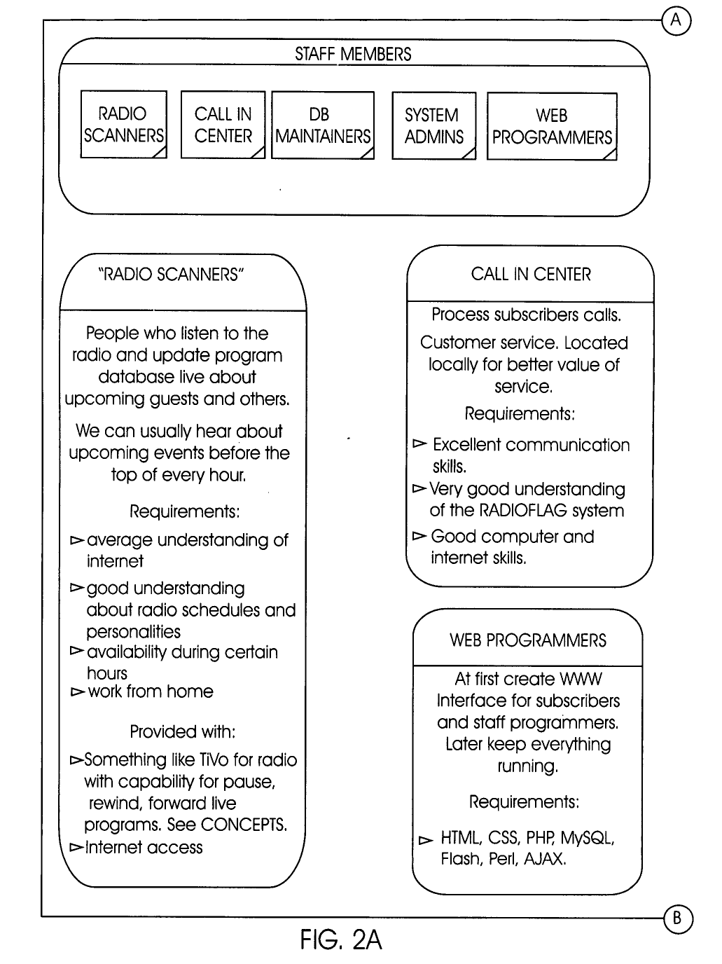

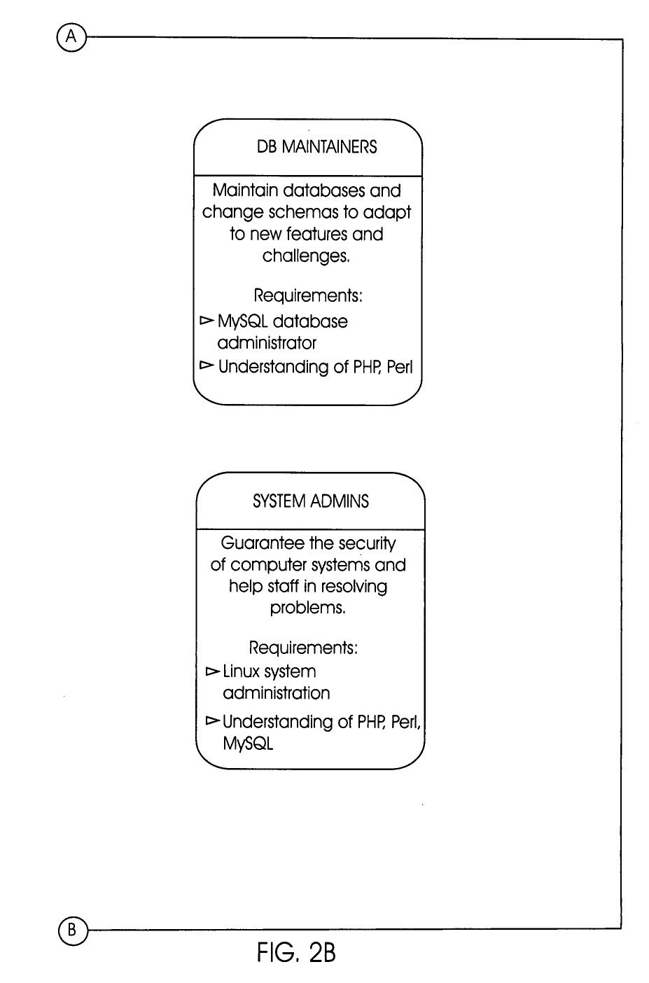

FIG. 2 illustrates, in a schematic diagram, outlining the assistance provided by the plurality of staff members in a radio flagging system 1000 of FIG. 1, in accordance with the present invention. A data entry staff and programmers are assigned to specific radio markets. The staff manually monitors those market radio stations for content and program the information into the database for processing and distribution to radio listeners. In order to eliminate the need for manual data entry when scanning the radio, the system 1000 further incorporates speech-recognition technology that transforms spoken words into alphanumeric text and navigational commands that can be recognized by a PC.

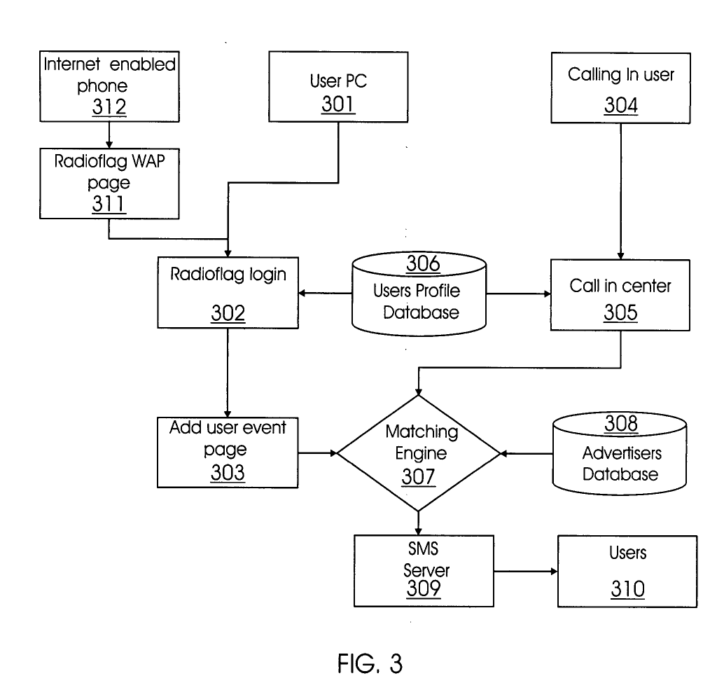

FIG. 3 illustrates, in a schematic diagram, outlining a plurality of scanners being users in a radio flagging system 1000, in accordance with the present invention. Viral advertisements are those that are used when a listener feels that a friend would be interested in the advertisement or broadcast and wants to alert the friend to it. The user forwards the message to the friend; and if the friend also interacts or opts-in, the system 1000 is compensated for generating the advertisement, i.e., utilizing the benefits of “word of mouth” and “endorsement by friends.” The system 1000 may also comprise a website which is community-driven, wherein an alert may be posted in a manner such as by using a personal computer, as indicated by block 301, using a call center, as indicated by block 304, and using a web-enabled cellular phone, as indicated by block 312.

In particular, a text alert in transmitted to the subscriber which is attached to a sponsor advertisement. The user will also have the option to participate with the advertiser who wishes to further his reach, thereby offering the user a special reward for his/her effort. If the user opts-in via a text message, instructions are sent to the user's e-mail address and cellular phone. By example only, if the advertiser is Microsoft, Inc., the advertiser instructs the user (if the user truly enjoys Microsoft® products) to approve one of several prepared personalized advertisement lines or slogans, e.g., “love this software.” The user photographs himself/herself, e.g., using his/her camera phone while sitting at a desktop with the product or anywhere else that the product is featured, and sends the photograph to a plurality of friends most likely to enjoy the message. The system 1000 further comprises a feature that enables the user to insert his composed message or slogan as well. Thus, the advertisement is made in a real life situation in the present invention. The message will then be sent via the system 1000, acting as a clearinghouse, whereby the advertisement generation is tracked. The persons receiving the message also receive written confirmation that the advertisement originates from the user, wherein the system 1000 is not identified. In addition, the cellular phone numbers are never used for any purpose whatsoever and are not even shared with the advertiser, unless one of the recipients then opts to interact with the advertiser via a text message.

Still referring to FIG. 3, for an alert being posted via a PC, a user logs onto the system 1000 via the PC, as indicated by blocks 301 and 302, and clicks the indicator for the link for adding the user event page, as indicated by block 303, wherein the user selects a topic for which he/she desires an alert sent to other persons, wherein the user describes the desired alert message as would be otherwise prepared by a scanner, wherein an alert from a user is sent to a matching engine, as indicated by block 307, and is processed in the same manner as it would otherwise be processed along with an automatically generated advertisement, wherein every user alert is logged with an identification number in order to track any user abuse, wherein a user is rewarded for his/her efforts by “alert points” which he/she can exchange for available rewards at a later time, and wherein the user shares in the revenue generated from the advertisements flowing from his alerts to other persons.

Also referring to FIG. 3, for an alert being posted via a call center, the user phones the call center, as indicated by block 304, whereby the user is prompted for log-in information, as indicated by block 305, wherein the user describes the desired alert message as would be otherwise prepared by a scanner wherein a alert from a user is sent to a matching engine, as indicated by block 307, and is processed in the same manner as it would otherwise be processed along with an automatically generated advertisement, as indicated by blocks 309 and 310, wherein every user alert is logged with an identification number in order to track any user abuse, wherein a user is rewarded for his/her efforts by “alert points” which he/she can exchange for available rewards at a later time, and wherein the user shares in the revenue generated from the advertisements flowing from his alerts to other persons. By example only, the software facilitates selecting a topic within a genre or other category by recognizing the first letter being typed into the system 1000 by the user and providing the user with selections starting with such letter. The user is prompted to accept a topical element from a list of choices.

In relation to FIG. 3, for an alert being posted via an Internet-enabled mobile device, such as a cellular phone, as indicated by block 312, the user log into a wireless application protocol (WAP) page, as indicated by block 304, whereby the user is prompted for log-in information, as indicated by block 302, wherein the user describes the desired alert message as would be otherwise prepared by a scanner, as indicated by block 303, wherein a alert from a user is sent to a matching engine, as indicated by block 307, and is processed in the same manner as it would otherwise be processed along with an automatically generated advertisement, as indicated by blocks 309 and 310, wherein every user alert is logged with an identification number in order to track any user abuse, wherein a user is rewarded for his/her efforts by “alert points” which he/she can exchange for available rewards at a later time, and wherein the user shares in the revenue generated from the advertisements flowing from his alerts to other persons.

The foregoing process can also be performed via e-mail to friends using a technique called “unsolicited ads in life” in the system 1000. By example only, if a subscriber is at Disneyland® and wishes to be compensated for advertising Disneyland® to his friends, then he would first determine whether Disneyland® is a system 1000 participant, e.g., in an “AdsInLife” program by signage located at the park or by visiting the website via WAP. If the user determines that the establishment is indeed a program participant, then the user may take a group photograph of himself/herself with friends by camera phone at the establishment and send the group photograph to several other friends. The user then texts the system 1000 via a short-code with a corresponding Disney® text message; and the system 1000 messages-back the instructions and rewards for sending the advertisement to the several other friends. The user then selects the pre-approved message, adds his composed message, and sends the advertisement via the system 1000, whereby the text message(s) is/are distributed to the several other friends. This can also be done via e-mail to the several other friends. Advertisements are also available for posting throughout the system 1000 website and WAP site.

Also referring to FIG. 3, an alert is identified, sorted, and matched with advertisements using persons who operating as scanners. Such persons are specialists focusing on one particular category or genre of interest, e.g., a person who is sports-oriented is assigned the task of monitoring the field of sports. Such person knows what radio broadcast content is relevant. When a pre-qualified broadcast is about to air, the specialist enters or keys a signal to prompt the alert to be sent. By example only, a live interview with David Beckham is imminent. The specialist would enter keywords or phrases such as “sports,” “soccer,” “Real Madrid,” “Los Angeles Galaxy,” “David Beckham interview,” and “rare.” In so doing, the system 1000 assures that all users, who are on various levels of interest, are alerted to the broadcast. Advertisements, matching those specific demographics and psychographics of each alerted subscriber, accompany the message. If a show has already been live-broadcast in one radio market and alerts have already been sent and recorded in the system 1000 database, a scanner is unnecessary if the same show is broadcast later as a prerecorded show in another market. The alerts are sent automatically corresponding to the appropriate times.

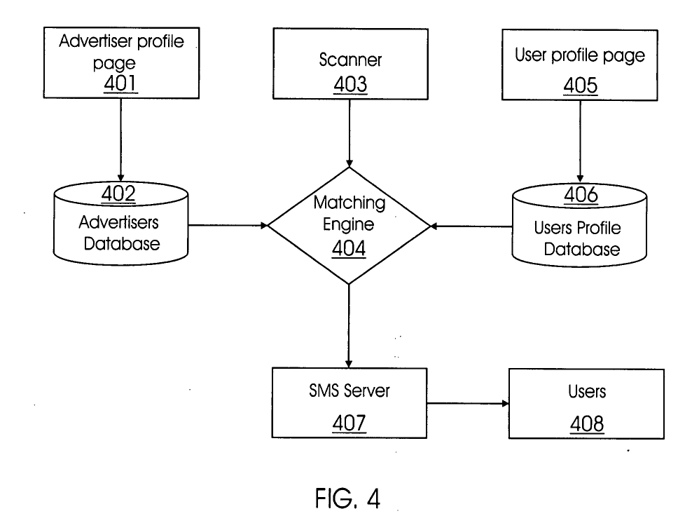

FIG. 4 illustrates, in a schematic diagram, an advertisement sending step in the present method of using a radio flagging system 1000, in accordance with the present invention. This diagram demonstrates the basic substeps in sending the SMS text message to the user and matching it with the target advertiser and the advertisement. The first substep comprises defining a target system 1000 user by an advertiser, wherein the system 1000 staff enter the advertiser's advertisement campaign specifics into an advertiser database, as indicated by blocks 401 and 402. In the second substep, the scanner or automated speech recognition software, which is monitoring the broadcasting of an event, enters the specifics of the broadcast, as indicated by block 403. In the third substep, the matching engine, using sophisticated algorithms, then matches the advertisement with the alert, as indicated by block 404. In the fourth substep, the same engine matches the alerted selected users with the advertisements, as indicated by blocks 405 and 406. In the fifth substep, the selected users and their contact mobile phone numbers are then fed to the “SMS Server,” as indicated by block 407, which then sends the SMS alerts to the users, as indicated by block 408.

Still referring to FIG. 4, an advertiser will be able to explore our database, and leverage the demographics and psychographics of subscribers that have been added to the system 1000 database for a micro-targeting campaign. By example only, if a sporting goods manufacturer recently produces a collector's “Kobe Bryant” jersey and wants to effectively market it, the manufacturer begins its search for sports fans, narrows the search to basketball fans, narrows the search to “Lakers” fans, and then narrows the search to “Kobe Bryant” fans specifically. When a text message is sent to a subscriber alerting him to a “Kobe Bryant” broadcast, the advertisement provided to the system 1000 by the advertiser/manufacturer will accompany the alert message.

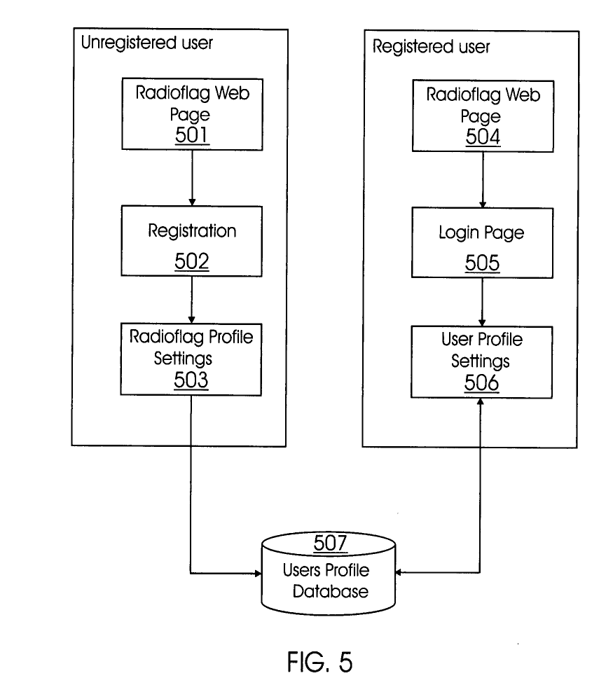

FIG. 5 illustrates, in a schematic diagram, a registering step in the present method of using a radio flagging system 1000, wherein a user profile is generated, in accordance with the present invention. In order to register and take advantage of all the system's features, users go to the website, www.radioflag.com, and register via a process, as indicated by blocks 501, 502, 503, whereby a plurality of registered users or subscribers are generated. The present method comprises generating profile settings, thereby enabling the users to set all of their alert preferences, as herein described, as indicated by block 503. The plurality of registered users or subscribers can then return at any time, as indicated by blocks 504, 505, 506, and modify their profiles using either a web browser or a web-enabled cellular phone. All the users' preferences are stored in a “user profile database,” as indicated by block 507. These preferences are later accessed by other components of the present system 1000 for managing and sending personalized SMS messages and for providing a wide range of other services and features as herein disclosed.

In relation to FIG. 5, the method M₂ of using the present invention flagging system 1000, comprises the steps of going to a website or WAP site for the system 1000 (by the user, as the subscriber, registering as a new member, providing user information, such as mobile phone information, e-mail address information, listening schedule information, work contact information, and residential contact information, e.g., a zip code, favorite radio station(s) information, etc., setting-up listening alert preferences profile using the web or WAP-enabled phone, thereby enabling subscribers to narrow their alerts by selecting from different levels of focus, e.g., “selecting sports, if not sufficiently focused, then selecting sports category and sports personality, if not sufficiently focused still, then selecting team, if not sufficiently focused still, then selecting a player or team member such as a coach, a manager, etc.”

By example only, if the subscriber listens all day to the radio via a mobile device and learns about a favorite team, e.g., the “Lakers,” an alert focusing on such topic is unnecessary. However, the present invention method M₂ of using the present invention system 1000 comprises the step of narrowing the search to a player, e.g., “Kobe Bryant,” because the subscriber would not want to miss hearing any interviews being conducted with this player or any in-depth discussions related to this player. The method M₂ of using the system 1000 comprises alerting the subscriber to broadcasts which are narrowly focused on this player, subsequently on any other player selected by the subscriber, and consequently on other “Laker”-related broadcasts that may interest the subscriber.

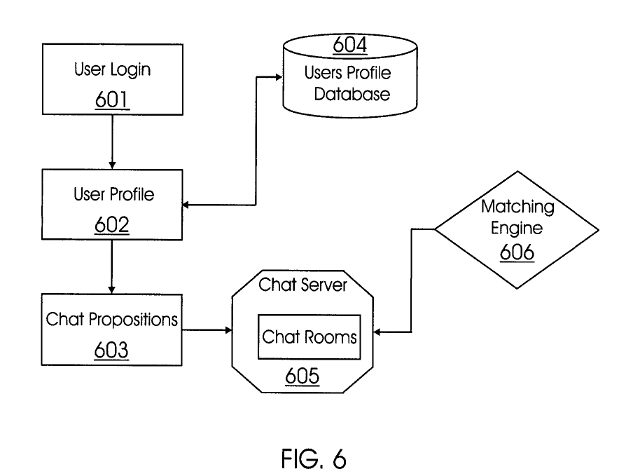

FIG. 6 is a schematic diagram of a user chat feature of a radio flagging system 1000, in accordance with the present invention. After a successful login, as indicated by block 601, the user is directed to his profile, as indicated by block 602. The system 1000 automatically retrieves all user information from the user profile database, as indicated by block 604. If the user had received any recent alerts during a specified time period and enough interest is generated in the same topics by other users, the system 1000 will then set-up “chat” rooms, focusing on the same topic, and present those links for those chat rooms to the identified users, the links being automatically generated on a chat server, as indicated by block 605, via the matching engine, as indicated by block 606. Thresholds for generating the chat rooms related to specific topics are set by administrators of the system 1000 based on the number of SMS messages being sent that are related to those specific topics during specific periods of time. For example only, the threshold is set by the system 1000 at 100 alerts; and 300 SMS messages have been sent to the users. This circumstance results in the matching engine creating a chat room on the chat server for this particular topic. Conversely, if the number of SMS messages is less than 100 alerts, no chat room is created; and users are not presented with any link to any room related to that topic or story.

In relation to FIG. 6, the present system 1000 further analyzes the demographics and psychographics of the mobile community. Text messages are sent, alerting subscribers to other subscribers who fall into the same demographic or psychographic category and who recently listened to the same broadcast and inviting them to chat with selected other subscribers about a given topic, story, or music. This text messaging option is performed by the system 1000 acting as the intermediary clearing house for messages, maintaining confidentiality of phone numbers. After a tune-in alert is received, the broadcast heard, and the advertisement has been read and or opted-in, another alert is sent to invite the user to chat via text messaging. A web chat is the primary chat venue available for the system 1000. Should the system 1000 deem a topic or a story to be of high priority in terms of popularity to its subscribers, those subscribers who were alerted to such topics or stories are then sent a link to their mobile device, by e-mail or by logging into the system 1000 website, whereby the users access the chat room and participate in chatting with other users about the broadcasted event.

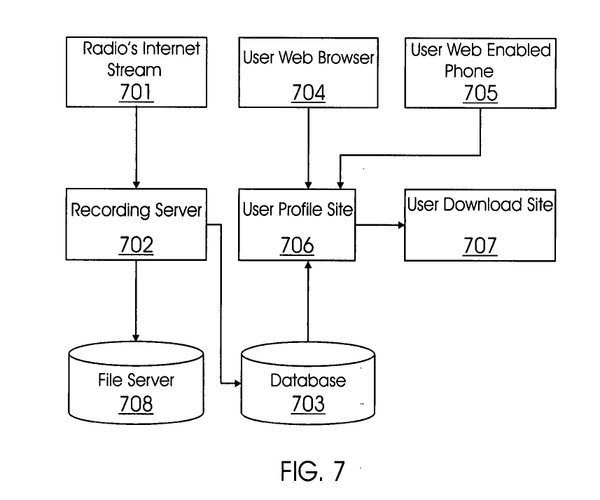

FIG. 7 illustrates, in a schematic diagram, a podcasting feature of a radio flagging system 1000, in accordance with the present invention. This flowchart presents the outline of the podcasting or flag-casting feature of the system 1000. First, the Internet radio stream, as indicated by block 701, is recorded by a recording server, as indicated by block 702. The identified sound recording is then clipped into 15-minute long segments and stored in a file server as a sound file, as indicated by block 708. Information identifying this specific segment is also stored in database, as indicated by block 703. Based on user-defined settings in the profile, as indicated by block 706, the user is presented with downloadable links, as indicated by block 707, to the file server, as indicated by block 708. The user is then enabled by the system 1000 for changing the settings and flag-casting preferences by using the web-enabled phone, as indicated by block 705, a regular web browser, as indicated by block 704, or touch-tone options operated phone.

For example, podcasting download commands will also be available to the system 1000 subscribers in the following manner. Should a subscriber be alerted to a broadcast and is unable to listen to the broadcast in real time, the subscriber may send a command to the system 1000 to record, to send, and to store the broadcasted segment of interest for later downloads. Should an alerted broadcast conflict with a subscriber's ability to tune-in real-time, an automated option is available in the system 1000 for allowing the subscriber to podcast or flag-cast the broadcast content directly to an iPod® folder for later downloading via a mobile phone in a short code manner. Messages will also be sent later as notification of available flag-casting downloads of missed shows or segments when a phone is deactivated. Should the stations participate in sharing its saved podcasts, then the system 1000 assembles a library of all radio podcasts of which subscribers can access. Users can then download to a cellular phone and then to an MP3® device. Also, a personalized flag-cast library is assembled by the subscriber. A sample of the flag-cast, following a broadcast, is available for listening on the mobile unit. As such, the subscriber decides whether to save and send it to his personal library for later listening, e.g., via a cellular phone or a headset. On audio-streaming-capable phones, a short code can be sent to request playing of a live flagged broadcast segment.

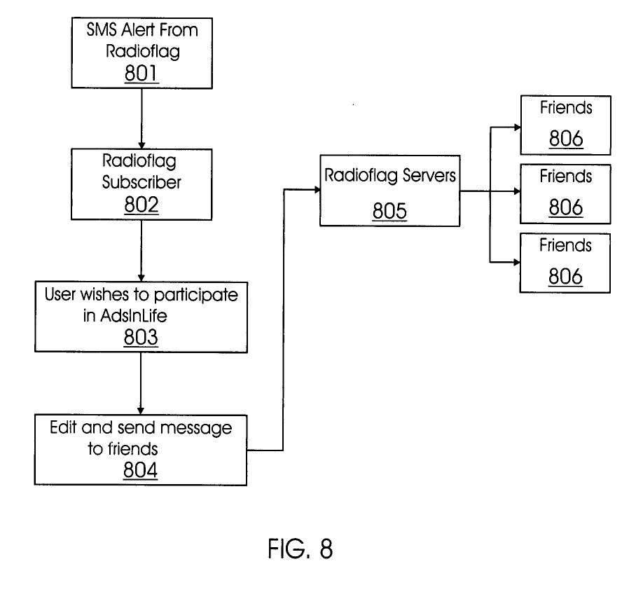

FIG. 8 illustrates, in a schematic diagram, an interactive advertisement feature of a radio flagging system 1000, wherein a user participates with an advertiser in furthering advertising by making an endorsement of the advertiser's products or services by using a digital photograph of the user and connecting such photograph with a form-advertisement or slogan, in accordance with the present invention. Specifically, a listener text alert is transmitted to a subscriber and is attached to a sponsor advertisement, as indicated by block 801. The user has the option of participating with the advertiser who wishes to further its reach, offering the user a special reward for the user's effort. If the user opts in via text, a set of instructions will be sent to the user's e-mail address, as indicated by block 802. By example only, if the advertiser is Microsoft, Inc., the advertiser instructs the user (if he truly enjoys Microsoft® products) to approve one of several prepares personalized advertisement lines or slogans, e.g., “love this software.” The user takes a digital photo, via camera or camera phone, of himself/herself, as described, supra, and as indicated by blocks 804 and 805. The recipient receives written confirmation that the advertisement originates from the subscriber with the system 1000 being anonymous, wherein the cellular phone numbers remain confidential, unless a recipient opts-in for interaction with an advertiser via text messaging, as indicated by block 806.

In relation to FIG. 8, several types of advertisement are handled by the present invention system 1000. Sponsor advertisements are those that simply feature an advertiser's name. Interactive advertisements are those that seek subscriber interaction by including a short code and instructions to text-back a specific word to opt-into an offer, e.g., receiving a coupon for an online purchase or for scanning at the physical store register. Advertisements target subscribers that the system 1000 recognizes as being likely to drive a specific route to, and from, work. Therefore, an advertisement alerting the user to a sale that is occurring at a store along that route may be sent to the user, which then increases the chances the user may stop on the way home to make a purchase.

The present invention also involves a method M₁ of providing a free, wireless, network-based system 1000 for providing listeners with managed, personalized, valued radio broadcast content, in real time, from a broadcasting entity, by way of a mobile device, for offering a mobile marketing medium to advertisers in order to micro-target consumers with advertisement, for leveraging unmatched psychographics and demographics, and for eliminating a need to surf radio channels, the method comprising the steps of: providing a network; providing a flagging software being made available via the network in a website; and providing at least one mobile device for entering user information by at least one user and for receiving, playing, storing, and retransmitting radio broadcast content, the at least one mobile device being capable of interfacing with the network.

The present invention also comprises a method M₁ of providing listeners with managed, personalized, valued radio broadcast content, in real time, from a broadcasting entity, of offering a mobile marketing medium to advertisers in order to micro-target consumers with advertisement, of leveraging unmatched psychographics and demographics, and of eliminating a need to surf radio channels, by way of a free, wireless, network-based system 1000, the method comprising the steps of: providing the free, wireless, network-based system 1000, the system 1000 providing step comprising the steps of: providing a network; providing a flagging software being made available via the network in a website; and providing at least one mobile device for entering user information by at least one user and for receiving, playing, storing, and retransmitting, radio broadcast content, the at least one mobile device being capable of interfacing with the network; registering at least one user, using the flagging software, as at least one subscriber; using the system 1000 by the at least one subscriber, thereby matching the at least one subscriber with at least one radio broadcast content; and downloading the at least one radio broadcast content via the at least one mobile device.

The method M₂ also comprises the step of setting another, or resetting, focused alert preferences differently for other teams or sports by the subscriber. This scheme will be the same for all topics in the selection menu. For example, the present invention system 1000 provides selectable main topics such as sports, health, fitness, science, politics, current events, pets, food, medical topics, home and garden, business/finance, legal topics, personal counseling, religion, music, fashion, entertainment/gossip, fashion, etc.

Also, the present invention system 1000 provides an additional alert options menu from which the subscriber may make selections. When setting the subscriber's alert preferences for each category, the subscriber will be able to select whether the subscriber desires an alert to unrelated broadcasts, i.e., “hot” alerts, which may still be of some interest to subscriber, such lesser priority broadcasts being determined by using an algorithm based on the user's/subscriber's profile. For instance, if the subscriber does want wish to be alerted to run-related broadcasts that may be of some interest, such as breaking hot stories or rare and exclusive interviews, then, even though the subscriber actually selects, for example, the “Boston Celtics,” but a rare interview with “Larry Bird” is being broadcast or a story regarding a block buster trade involving the “Chicago Bulls” is being broadcast, then the subscriber may still be alerted to such “breaking” radio broadcast content. These hot alerts will be rated by a scoring system 1000 depending on an importance scale or a relevancy scale.

Also the present invention system 1000 provides a section of a home page that features news about all categories. These stories list headlines of breaking news stories provided via “Really Simple Syndication” (RSS), a “web feed” which feeds content from significant online news sites. In this manner, the subscriber can also obtain select news via the present invention flagging system 1000, because the most significant news stories become available as selectable topics by the subscriber. The subscriber can then check boxes adjacent the web links to request alerts relating to the corresponding headlines. If the subscriber wishes to read the entire story on a mobile device, then the subscriber clicks the link and reads the source-provided story, rather than listening to it. The subscriber can also set a minimum number as well as a maximum number of alerts that the subscriber may receive on any given day. Also, the subscriber can select the option for receiving alerts from programs being broadcast on the Internet that originate from other radio markets, thereby rendering the present invention system 1000 useful to listeners who are near a computer at a specific time.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public, regardless of whether the element, component, or method step is explicitly recited in the claims. However, that various changes and modifications in form, material, and fabrication material detail may be made, without departing from the spirit and scope of the inventions as set forth in the appended claims, should be readily apparent to those of ordinary skill in the art as being encompassed by the present invention. No claim herein is to be construed under the provisions of 35 U.S.C. § 112, sixth paragraph, unless the element is expressly recited using the phrase “means for.”

### INDUSTRIAL APPLICABILITY

The present invention industrially applies to systems and methods for matching listeners with sound providers. More particularly, the present invention industrially applies to systems and methods for matching radio listeners with radio broadcast providers. Even more particularly, the present invention industrially applies to systems and methods for matching radio listeners with selected and targeted radio broadcast content.

What is claimed:

1. A free, wireless, network-based system for providing listeners with managed, personalized, valued radio broadcast content, in real time, from a broadcasting entity, by way of a mobile device, for offering a mobile marketing medium to advertisers in order to micro-target consumers with advertisement, for leveraging unmatched psychographics and demographics, and for eliminating a need to surf radio channels, the system comprising:
a network;
a flagging software being made available via the network in a website; and
at least one mobile device for entering user information by at least one user and for receiving, playing, storing, and retransmitting, radio broadcast content, the at least one mobile device being capable of interfacing with the network.

2. A system, as recited in claim 1, wherein the network comprises the Internet.

3. A system, as recited in claim 1, wherein the flagging software comprises means for iteratively computing a degree of matching.

4. A system, as recited in claim 3, wherein the iteratively computing means comprises:
(a) means for identifying at least one user attribute from the user information, whereby a user profile is generated;
(b) means for matching a profile of the at least one user attribute with a profile of at least one provider, the at least one provider being selected from a group consisting essentially of the broadcasting entity and the advertiser, whereby a degree of matching is computed;
(c) means for computing an initial degree of matching between the at least one user profile and the at least one provider profile;
(d) means for cyclically generating requests for additional information from the at least one user and the at least one provider as a cascading series of requests for additional information by automatically referencing the user information and cyclically receiving at least one response from the at least one user and the at least one provider;
(e) means for reconstructing the at least one user profile and the at least one provider profile based on the at least one response; and
(f) means for recomputing the degree of matching, whereby a plurality of matching results are generated.

5. A system, as recited in claim 4, wherein the flagging software further comprises:
means for selecting a radio broadcast based on the plurality of matching results, whereby at least one radio broadcast is selected; and
means for transmitting the at least one selected radio broadcast to the at least one user.

6. A system, as recited in claim 1,
wherein the at least one user registers with the system as at least one subscriber using the flagging software, and
wherein the flagging software comprises means for flagging at least one radio broadcast of interest selected from a group consisting essentially of a radio show and any other on-air content that is specified by the at least one subscriber.

7. A system, as recited in claim 1, wherein the flagging software comprises means for alerting, and prompting tuning by, the at least one subscriber to the at least one radio broadcast of interest.

8. A system, as recited in claim 1, wherein the flagging software further comprises means for sending a message to the mobile device.

9. A system, as recited in claim 8, wherein the message comprises a text message.

10. A system, as recited in claim 1, wherein the flagging software further comprises means for performing at least one function selected from a group consisting essentially of downloading the radio broadcast content in real time and saving the radio broadcast content for later downloading.

11. A system, as recited in claim 1, wherein the flagging software further comprises at least one searching feature.

12. A system, as recited in claim 11, wherein the searching feature comprises at least one feature selected from a group consisting essentially of a voice-recognition feature and a voice-scanning feature.

13. A system, as recited in claim 11, wherein the searching feature is operable with at least one broadcast type selected from a group consisting essentially of a terrestrial broadcast type, a satellite broadcast type, a network broadcast type, and an Internet broadcast type.

14. A system, as recited in claim 11,
wherein the searching feature comprises a searching-and-matching engine,
wherein the searching and matching engine comprises means for seeking verbal content, means for filtering the verbal content, and means for distributing the verbal content via a messaging technique,
wherein the messaging technique comprises at least one technique selected from a group consisting essentially of text messaging and short messaging, and
whereby the at least one user is notified of at least one pre-qualified, valued radio broadcast content.

15. A system, as recited in claim 14, wherein the searching-and-matching engine provides a sampling of the at least one pre-qualified, valued radio broadcast content.

16. A system, as recited in claim 1, wherein the flagging software comprises a program which provides podcasting download-commands.

17. A system, as recited in claim 1, wherein the flagging software is automated.

18. A system, as recited in claim 1, further comprising assistance for customizing service for specific radio markets, the assistance being provided by at least one element selected from t a group consisting essentially of a data entry staff and at least one programmer.

19. A system, as recited in claim 1,
wherein the network comprises the Internet,
wherein the flagging software comprises means for iteratively computing a degree of matching,
wherein the iteratively computing means comprises:
(a) means for identifying at least one user attribute from the user information, whereby a user profile is generated;
(b) means for matching a profile of the at least one user attribute with a profile of at least one provider, the at least one provider being selected from a group consisting essentially of the broadcasting entity and the advertiser, whereby a degree of matching is computed;
(c) means for computing an initial degree of matching between the at least one user profile and the at least one provider profile;
(d) means for cyclically generating requests for additional information from the at least one user and the at least one provider as a cascading series of requests for additional information by automatically referencing the user information and cyclically receiving at least one response from the at least one user and the at least one provider;
(e) means for reconstructing the at least one user profile and the at least one provider profile based on the at least one response; and
(f) means for recomputing the degree of matching, whereby a plurality of matching results are generated,
wherein the flagging software further comprises means for selecting a radio broadcast based on the plurality of matching results, whereby at least one radio broadcast is selected, and means for transmitting the at least one selected radio broadcast to the at least one user,
wherein the at least one user registers with the system as at least one subscriber using the flagging software,
wherein the flagging software comprises means for flagging at least one radio broadcast of interest selected from a group consisting essentially of a radio show and any other on-air content that is specified by the at least one subscriber,
wherein the flagging software comprises means for alerting, and prompting tuning by, the at least one subscriber to the at least one radio broadcast of interest,
wherein the flagging software further comprises means for sending a message to the mobile device, wherein the message comprises a text message,
wherein the flagging software further comprises means for performing at least one function selected from a group consisting essentially of downloading the radio broadcast content in real time and saving the radio broadcast content for later downloading,
wherein the flagging software further comprises at least one searching feature, wherein the searching feature comprises at least one feature selected from a group consisting essentially of a voice-recognition feature and a voice-scanning feature, wherein the searching feature is operable with at least one broadcast type selected from a group consisting essentially of a terrestrial broadcast type, a satellite broadcast type, a network broadcast type, and an Internet broadcast type,
wherein the searching feature comprises a searching-and-matching engine,
wherein the searching and matching engine comprises means for seeking verbal content, means for filtering the verbal content, and means for distributing the verbal content via a messaging technique, wherein the messaging technique comprises at least one technique selected from a group consisting essentially of text messaging and short messaging, whereby the at least one use is notified of at least one pre-qualified, valued radio broadcast content,
wherein the searching-and-matching engine provides a sampling of the at least one pre-qualified, valued radio broadcast content,
wherein the flagging software comprises a program which provides podcasting download-commands, and
wherein the flagging software is automated.

20. A method of providing a free, wireless, network-based system for providing listeners with managed, personalized, valued radio broadcast content, in real time, from a broadcasting entity, by way of a mobile device, for offering a mobile marketing medium to advertisers in order to micro-target consumers with advertisement, for leveraging unmatched psychographics and demographics, and for eliminating a need to surf radio channels, the method comprising the steps of:
providing a network;
providing a flagging software being made available via the network in a website; and
providing at least one mobile device for entering user information by at least one user and for receiving, playing, storing, and retransmitting, radio broadcast content, the at least one mobile device being capable of interfacing with the network.

21. A method, as recited in claim 20, wherein the network providing step comprises providing the Internet.

22. A method, as recited in claim 20, wherein the flagging software providing step comprises providing means for iteratively computing a degree of matching.

23. A method, as recited in claim 22, wherein the iteratively computing means providing step comprises the steps of:
(a) providing means for identifying at least one user attribute from the user information, whereby a user profile is generated;
(b) providing means for matching a profile of the at least one user attribute with a profile of at least one provider, the at least one provider being selected from a group consisting essentially of the broadcasting entity and the advertiser, whereby a degree of matching is computed;
(c) providing means for computing an initial degree of matching between the at least one user profile and the at least one provider profile;
(d) providing means for cyclically generating requests for additional information from the at least one user and the at least one provider as a cascading series of requests for additional information by automatically referencing the user information and cyclically receiving at least one response from the at least one user and the at least one provider;
(e) providing means for reconstructing the at least one user profile and the at least one provider profile based on the at least one response; and
(f) providing means for recomputing the degree of matching, whereby a plurality of matching results are generated.

24. A method, as recited in claim 23, wherein the flagging software providing step further comprises:
providing means for selecting a radio broadcast based on the plurality of matching results, whereby at least one radio broadcast is selected; and
providing means for transmitting the at least one selected radio broadcast to the at least one user.

25. A method, as recited in claim 20,
wherein the flagging software providing step comprises providing means for flagging at least one radio broadcast of interest selected from a group consisting essentially of a radio show and any other on-air content that is specified by the at least one subscriber.

26. A method, as recited in claim 20, wherein the flagging software providing step comprises providing means for alerting, and prompting tuning by, the at least one subscriber to the at least one radio broadcast of interest.

27. A method, as recited in claim 20, wherein the flagging software providing step further comprises providing means for sending a message to the mobile device.

28. A method, as recited in claim 27, wherein the sending means providing step comprises providing the message as a text message.

29. A method, as recited in claim 20, wherein the flagging software providing step further comprises providing means for performing at least one function selected from a group consisting essentially of downloading the radio broadcast content in real time and saving the radio broadcast content for later downloading.

30. A method, as recited in claim 20, wherein the flagging software providing step further comprises providing at least one searching feature.

31. A method, as recited in claim 30, wherein the searching feature providing step comprises providing at least one feature selected from a group consisting essentially of a voice-recognition feature and a voice-scanning feature.

32. A method, as recited in claim 30, wherein the searching feature providing step comprises providing the searching feature being operable with at least one broadcast type selected from a group consisting essentially of a terrestrial broadcast type, a satellite broadcast type, a network broadcast type, and an Internet broadcast type.

33. A method, as recited in claim 30,
wherein the searching feature providing step comprises providing a searching-and-matching engine,
wherein the searching and matching engine providing step comprises providing means for seeking verbal content, providing means for filtering the verbal content, and providing means for distributing the verbal content via a messaging technique, and
wherein the distributing means providing step comprises providing the messaging technique as at least one technique selected from a group consisting essentially of text messaging and short messaging.

34. A method, as recited in claim 33, wherein the searching-and-matching engine providing step comprises providing a sampling of the at least one pre-qualified, valued radio broadcast content.

35. A method, as recited in claim 20, wherein the flagging software providing step comprises providing a program which provides podcasting download-commands.

36. A method, as recited in claim 20, wherein the flagging software providing step comprises automating the flagging software.

37. A method, as recited in claim 20, further comprising the step of providing assistance for customizing service for specific radio markets, the assistance being provided by at least one element selected from a group consisting essentially of a data entry staff and at least one programmer.

38. A method, as recited in claim 20,
wherein the network providing step comprises providing the Internet,
wherein the flagging software providing step comprises providing means for iteratively computing a degree of matching,
wherein the iteratively computing means providing step comprises the steps of:
(a) providing means for identifying at least one user attribute from the user information, whereby a user profile is generated;
(b) providing means for matching a profile of the at least one user attribute with a profile of at least one provider, the at least one provider being selected from a group consisting essentially of the broadcasting entity and the advertiser, whereby a degree of matching is computed;
(c) providing means for computing an initial degree of matching between the at least one user profile and the at least one provider profile;
(d) providing means for cyclically generating requests for additional information from the at least one user and the at least one provider as a cascading series of requests for additional information by automatically referencing the user information and cyclically receiving at least one response from the at least one user and the at least one provider;
(e) providing means for reconstructing the at least one user profile and the at least one provider profile based on the at least one response; and
(f) providing means for recomputing the degree of matching, whereby a plurality of matching results are generated,
wherein the flagging software providing step further comprises:
providing means for selecting a radio broadcast based on the plurality of matching results, whereby at least one radio broadcast is selected; and
providing means for transmitting the at least one selected radio broadcast to the at least one user,
wherein the flagging software providing step comprises providing means for flagging at least one radio broadcast of interest selected from a group consisting essentially of a radio show and any other on-air content that is specified by the at least one subscriber,
wherein the flagging software providing step comprises providing means for alerting, and prompting tuning by, the at least one subscriber to the at least one radio broadcast of interest,
wherein the flagging software providing step further comprises providing means for sending a message to the mobile device, wherein the sending means providing step comprises providing the message as a text message,
wherein the flagging software providing step further comprises providing means for performing at least one function selected from a group consisting essentially of downloading the radio broadcast content in real time and saving the radio broadcast content for later downloading,
wherein the flagging software providing step further comprises providing at least one searching feature, wherein the searching feature providing step comprises providing at least one feature selected from a group consisting essentially of a voice-recognition feature and a voice-scanning feature,
wherein the searching feature providing step comprises providing the searching feature being operable with at least one broadcast type selected from a group consisting essentially of a terrestrial broadcast type, a satellite broadcast type, a network broadcast type, and an Internet broadcast type,
wherein the searching feature providing step comprises providing a searching-and-matching engine, wherein the searching and matching engine providing step comprises providing means for seeking verbal content, providing means for filtering the verbal content, and providing means for distributing the verbal content via a messaging technique,
wherein the distributing means providing step comprises providing the messaging technique as at least one technique selected from a group consisting essentially of text messaging and short messaging,
wherein the searching-and-matching engine providing step comprises providing a sampling of the at least one pre-qualified, valued radio broadcast content,
wherein the flagging software providing step comprises providing a program which provides podcasting download-commands, and
wherein the flagging software providing step comprises automating the flagging software.

39. A method of providing listeners with managed, personalized, valued radio broadcast content, in real time, from a broadcasting entity, of offering a mobile marketing medium to advertisers in order to micro-target consumers with advertisement, of leveraging unmatched psychographics and demographics, and of eliminating a need to surf radio channels, by way of a free, wireless, network-based system, the method comprising the steps of:
providing the free, wireless, network-based system, the system providing step comprising the steps of:
providing a network;
providing a flagging software being made available via the network in a website; and
providing at least one mobile device for entering user information by at least one user and for receiving, playing, storing, and retransmitting, radio broadcast content, the at least one mobile device being capable of interfacing with the network;
registering at least one user, using the flagging software, as at least one subscriber;
using the system by the at least one subscriber, thereby matching the at least one subscriber with at least one radio broadcast content; and
downloading the at least one radio broadcast content via the at least one mobile device.
